(19) United States
(12) Patent Application Publication
(10) Pub. No.: US 2025/0259189 A1
(43) Pub. Date: Aug. 14, 2025

(54) Wave-Induced Collapse of Quantum and Probabilistic Systems via Observer Interference

(71) Applicant: Larry Kheng Cheong Lim, Singapore (SG)

(72) Inventor: Larry Kheng Cheong Lim, Singapore (SG)

(21) Appl. No.: 19/173,849

(22) Filed: Apr. 9, 2025

Related U.S. Application Data
(63) Continuation-in-part of application No. 19/172,805, filed on Apr. 8, 2025.

(51) Int. Cl. G06Q 30/0201; G06N 10/60

(52) U.S. Cl. CPC G06Q 30/0201; G06N 10/60

(57) ABSTRACT

This Continuation-in-Part extends the wave-interference-based collapse model first proposed in the Modified Schrödinger Equation (MSE) framework to five foundational quantum phenomena: tunneling, entanglement, measurement collapse, time asymmetry, and the resolution of Many-Worlds interpretations.

The invention models collapse as a physical consequence of interference between the observer wave and the quantum system wavefunction, characterized by a curvature-based localization mechanism. This framework enables tunable collapse control, non-binary measurement outcomes, and outcome selection through engineered interference, providing a unified physical mechanism with broad technological applications.

### I. BACKGROUND OF THE INVENTION

The central paradox in quantum mechanics is the collapse of the wavefunction upon observation. In the double-slit experiment, particles display interference patterns in the absence of observation, yet behave as localized particles when observed. While the probabilistic nature of collapse is accepted as an axiom (e.g., Born rule), no physical mechanism has ever been universally accepted to explain how or why collapse occurs.

Orthodox interpretations treat measurement as an abstract event—not as a physical interaction. Some explanations, such as spontaneous localization or decoherence theory, model collapse as emergent from environment-system coupling, but these models still rely on indirect or statistical mechanisms. The Many-Worlds Interpretation removes collapse entirely but leads to an unresolved branching ontology. None of these approaches explain the physical process of collapse as a function of interference between waves.

This invention addresses that gap directly by modeling the observer as a physical wave-emitting body, capable of interacting with the quantum system through wave-to-wave interference. The collapse is not due to information or epistemic limits, but due to real overlap between the observer's wavefunction and that of the particle.

### II. COMPARISON WITH THE STANDARD SCHRÖDINGER EQUATION

The standard linear Schrödinger equation for a free particle is:

$$i ℏ \frac{\partial {Ψ}_{p} ( r , t )}{\partial t} = - \frac{{ℏ}^{2}}{2 m} {∇}^{2} {Ψ}_{p} ( r , t )$$

This describes unitary evolution without collapse or localization. It lacks any term accounting for measurement, observation, or interference.

In contrast, the invention introduces the following observer-interference modified Schrödinger equation:

$$i ℏ \frac{\partial {Ψ}_{p} ( r , t )}{\partial t} = ( - \frac{{ℏ}^{2}}{2 m} {∇}^{2} + V ( r ) + γ {\vert {Ψ}_{o} ( r , t ) \vert}^{2} - δ {Ψ}_{o} ( r , t ) ) {Ψ}_{p} ( r , t )$$

This formulation introduces physically motivated interaction terms:—γ|Ψₒ|²: amplification due to attention (coherent wave overlap)—δΨₒ: dissipation or decoherence induced by the observer

These terms enable collapse behavior to emerge continuously and deterministically.

### III. SUMMARY OF THE INVENTION

This invention introduces a physical mechanism for wavefunction collapse, arising from wave-to-wave interference between a quantum system's wavefunction and that of a coherent observer. Unlike classical probabilistic measurement models, this framework models the observer as a physical wave-emitting entity that can influence quantum systems through direct nonlinear interaction.

The collapse of the particle wavefunction Ψₚ(r, t) is governed by a modified Schrödinger equation that includes both amplification and dissipation terms linked to the observer's wavefunction Ψₒ(r, t):

$$i ℏ \frac{\partial {Ψ}_{p} ( r , t )}{\partial t} = ( - \frac{{ℏ}^{2}}{2 m} {∇}^{2} + V ( r ) + γ {\vert {Ψ}_{o} ( r , t ) \vert}^{2} - δ {Ψ}_{o} ( r , t ) ) {Ψ}_{p} ( r , t )$$

Where:—γ: attention amplification coefficient—δ: observation-induced dissipation coefficient—Ψₒ(r, t): observer's coherent wave presence

Collapse is triggered by constructive phase-aligned interference when the observer's wave is coherent, intense, and in phase with the particle wave. The model defines a relative phase angle:

$$Δθ = {θ}_{o} - {θ}_{p}$$

Constructive interference (cos Δθ>0) increases localization, while destructive interference (cos Δθ<0) delays or disperses collapse. This explains variability in experimental results such as delayed-choice measurements, weak observations, and biological observer proximity effects.

Unlike previous probabilistic or many-worlds interpretations, this model provides a continuous, deterministic mechanism for wavefunction localization based on quantifiable physical overlap. It allows predictions and simulations of collapse outcomes based on controllable parameters: phase, amplitude, spatial alignment, and coherence of Ψₒ.

### IV. DETAILED DESCRIPTION OF THE INVENTION

The collapse behavior in this model arises from the nonlinear interaction between the wave-function of a particle Ψₚ and a wavefunction radiated by the observer Ψₒ. This is a fundamental departure from conventional interpretations that postulate measurement collapse without physical cause.

A central innovation in this invention is the treatment of the observer not as a passive measurer, but as a quantum-coherent emitter of a localized waveform Ψₒ(r, t), whose amplitude and phase interact with the quantum system. Collapse is not a discontinuous projection, but a wave-induced localization that results from constructive interference.

The key component of this interaction is the relative phase difference:

$$Δθ ( r , t ) = {θ}_{o} ( r , t ) - {θ}_{p} ( r , t )$$

$$CollapseIntensity ∝ cos ( Δθ ( r , t ) ) \cdot {\vert {Ψ}_{o} ( r , t ) \vert}^{2}$$

—cos(Δθ)>0: constructive interference, enhances local probability density—cos(Δθ)<0: destructive interference, disperses the wavefunction

This predicts collapse and its timing dynamically, modulated experimentally by coherence, distance, and observer phase.

$${Ψ}_{p}^{″} ( t ) = \frac{{d}^{2}}{{dt}^{2}} 〈 x ( t ) 〉$$

This second derivative (concavity of the probability center) offers a measurable signal of collapse onset or rebound.

### V. APPLICATIONS

This CIP builds upon the physical wave collapse mechanism presented in the parent patent by extending it into new practical domains. It identifies nine application areas, each leveraging a specific behavior or controllable parameter of the observer-induced collapse system.
1. Entanglement Enablement: Collapse of an entangled wavefunction can be guided by the presence of a synchronized observer field. The invention allows for selective triggering of one particle's collapse in a controlled manner, enabling new mechanisms for remote collapse or observer-driven entanglement switching.
2. Tunneling Modification: The interference terms introduced here allow observer wave coherence to suppress or delay tunneling transitions. This results in real-time modulation of tunneling rates, with implications for quantum dot switching, molecular transport, and biological coherence barriers.
3. Medical Diagnostics and Imaging: The presence or absence of collapse in response to biological wave coherence provides a mechanism for sensing, imaging, or treating localized disorders. Sensors can detect abnormal coherence levels or wave suppression zones.
4. Military and Defense Systems: Observer-modulated collapse can be used for quantum sensing, targeting, jamming, or shielding. The invention enables directional detection or nullification of collapse, enhancing security, privacy, and countermeasures.
5. Quantum Control and AI Feedback Loops: Collapse fields can be steered in real time by AI algorithms generating observer wave patterns. Feedback loops allow the system to “learn” collapse triggers and enhance measurement precision.
6. Quantum Memory and Collapse-Based Storage: Stable collapse zones, guided by feedback interference, can serve as write/read quantum memory cells. Memory integrity is preserved through constructive interference locking, without destructive measurement.
7. Quantum Cryptography: Collapse curvature signals can serve as keys. The collapse curvature Ψ″ₚ(t) encodes localized collapse information which can be used as time-locked keys or for tamper-evident collapse chains.
8. Bio-Interference Systems: Human brainwaves, heart EM fields, or biological rhythms can interact with quantum systems via observer collapse. Devices can detect or entrain biofields, with applications in medicine, neural tech, and biosecurity.
9. Educational and Philosophical Tools: The model provides a visually intuitive framework to explain collapse to non-physicists. It replaces mystical explanations with physical wave interactions, offering a deterministic view of measurement.

### VI. CONCLUSION

This invention establishes that wavefunction collapse can be modeled as interference between a quantum system and the coherent wavefunction of an observer. It defines the collapse mechanism in terms of phase interaction and derives a modified Schrödinger equation incorporating observer-dependent amplification and dissipation.

It introduces a novel second-derivative collapse signal Ψ″ₚ(t), interprets phase shift Δθ as a localization guide, and connects this framework to quantum memory, AI collapse control, tunneling, biological sensing, and more.

Collapse becomes not an unexplained projection, but a predictable, modifiable interference behavior. The invention is testable, extensible, and scalable across quantum, biological, and computational platforms.
Nonlinear observer-dependent collapse equation with amplification γ and dissipation δ
Phase interference dynamics governed by Δθ=θₒ−θₚ
Curvature signal Ψ″ₚ(t) to forecast collapse onset
Testable across experimental platforms including delayed-choice, biological proximity, and AI-modulated collapse

### VII. STATEMENT OF NO NEW MATTER

This specification does not introduce new matter beyond the original disclosure in application Ser. No. 19/172,805. All additions elaborate upon or extend the same foundational theory into applied, testable, and controllable systems.

1. A method for observer-induced wavefunction collapse comprising: step A, step B, and step C.

2. The method of claim 1, wherein the collapse mechanism is modulated by the observer's wave coherence.

3. A system that simulates particle detection events based on wave interference dynamics.

4. The method of claim 1, applied to antimatter waveforms.

5. A nonlocal interaction model where the observer's wave amplitude modulates apparent localization.

6. A collapse index derived from the overlap integral of particle and observer wavefunctions.

7. An economic forecasting method using quantum collapse analogies to model market tipping points.

8. The system of claim 3, further comprising feedback loops using second-derivative curvature Ψ″ₚ(t).

9. A phase interference metric for collapse forecasting derived from Hilbert-transformed phase angles.

10. A biological sensor integrating observer feedback for quantum state modulation.

11. A tunneling suppression mechanism activated via external observer field reinforcement.

12. A quantum memory system stabilized using self-coherent observer-wave interference.

13. The method of claim 1, implemented within a modified Schrödinger equation framework.

14. A computer program product configured to simulate wave-interference-driven localization events.

15. A probabilistic model where classical randonmess emerges from wave-to-wave interference collapse.
